(19) United States
(12) Patent Application Publication
(10) Pub. No.: US 2006/0012132 A1
(43) Pub. Date: Jan. 19, 2006

(54) Muffler washer for draft link of mold base

(76) Inventor: Lai Wen Wu, Hsinchu Hsien (TW)

Correspondence Address: LEONG C LEI, PMB # 1008, 1867 YGNACIO VALLEY ROAD, WALNUT CREEK, CA, 94598, US

(21) Appl. No.: 10/890,168

(22) Filed: Jul. 14, 2004

(51) Int. Cl. F16J 15/02

(52) U.S. Cl. 277/628

(57) ABSTRACT

A muffler washer for the draft link of a mold base including a resin made ring body and a metal ring; the metal ring being inserted into the outer wall of the ring body; the ring body being provided with sufficient compression resisting strength; and the washer being inserted to the catch of the draft link to eliminate noise generated by the catch upon hitting the mold plate.

### BACKGROUND OF THE INVENTION

(a) Technical Field of the Invention

The present invention is related to a muffler washer for the draft link of a mold base, and more particularly to one that eliminates noise generated when a catch of the draft link of the mold base hit against the edge of mold plate stopper.

(b) Description of the Prior Art

Higher noise level at work place is one of the causes leading to occupational hazards since the operator who is exposed to noise long-term can easily feel fatigue, and have reduced work efficiency and failure of concentration. Therefore, how to minimize the noise level at work place has been addressed particularly in the industry of machinery works.

In the application of the mold base construction, the closing up and separation between mold plates are necessary and frequent in the operation. The mold base construction of the prior art has a flange disposed at the catch of the draw link directly functioning as a stopper to secure a mold plate in place. However, when the catch hits the edge of the mold plate stopper, noise of metal impact is generated at a level increasing in proportion to the number of the mold plates. So far, there has been no effective way to solve the noise problem.

### SUMMARY OF THE INVENTION

The primary purpose of the present invention is to provide a muffler washer for a draft link of a mold base that eliminates the noise generated when the catch of the draft link hits the stopper edge of the mold plate. To achieve the purpose, the muffler washer includes a resin made ring body and a metal ring with the latter being inserted into the former to improve the compression resisting strength of the ring body, and the washer is then inserted to a catch of the draft link of the mold base.

Another purpose of the present invention is to provide a muffler washer for a draft link of a mold base that effectively minimizes the vibration caused by the impacts between the draft link and the mold plate. To achieve the purpose, the metal ring is forthwith clad in the inner wall of the ring body to upgrade the fixation of the incorporation between the metal ring and the ring body; furthermore, slots are separately provided on the top and the bottom of the ring body to reduce the area of contact so to provide the ring body better resilience without compromising its compression resisting property.

The foregoing object and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a schematic view showing an assembly of a first preferred embodiment of the present invention.

FIG. 2 is a sectional view of the first preferred embodiment of the present invention.

FIG. 3 is a schematic view showing the first preferred embodiment of the present invention in service.

FIG. 4 is another schematic view showing the first preferred embodiment of the present invention in service.

FIG. 5 is a schematic view showing an assembly of a second preferred embodiment of the present invention.

FIG. 6 is a sectional view of the second preferred embodiment of the present invention.

### DETAILED DESCRIPTION OF THE PREFERRED EMBODIMENTS

The following descriptions are of exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

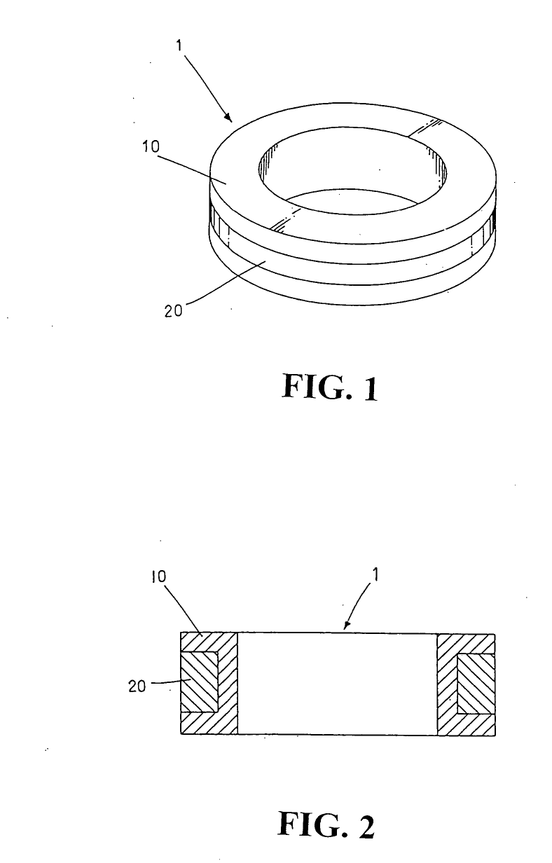

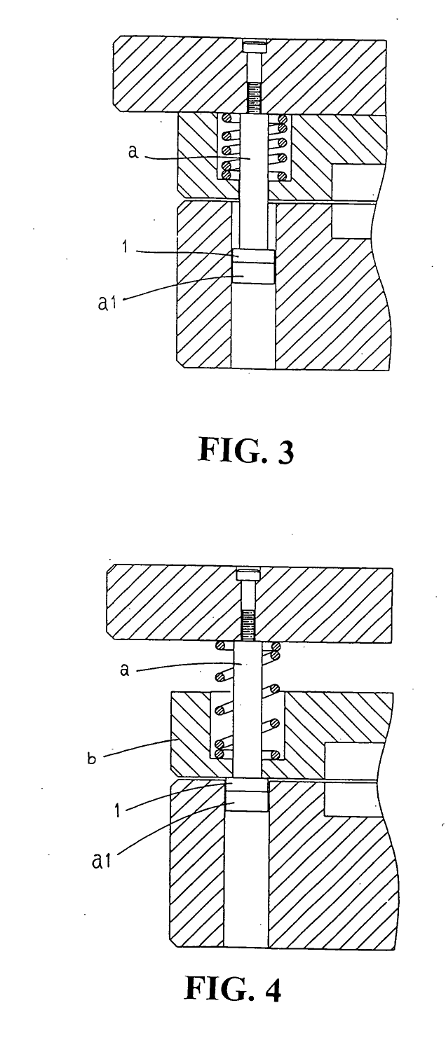

Referring to FIGS. 1 and 2, a first preferred embodiment of the present invention is related to a muffler washer (1) comprised of a ring body made of resin (10) and a metal ring (20). Wherein, the metal ring (20) is inserted into the external wall of the ring body (10). Also as illustrated in FIGS. 1 through 4, the washer (1) comprised of the ring body (10) and the metal ring (20) is coupled to a catch (a1) from a draft link (a) of a mold base. When the catch (a1) hits against a stopper edge of a mold plate (b), the ring body (10) absorbs vibration and noise generated from the impact while the metal ring (20) provides sufficient compression strength to significantly extend the service life of the washer.

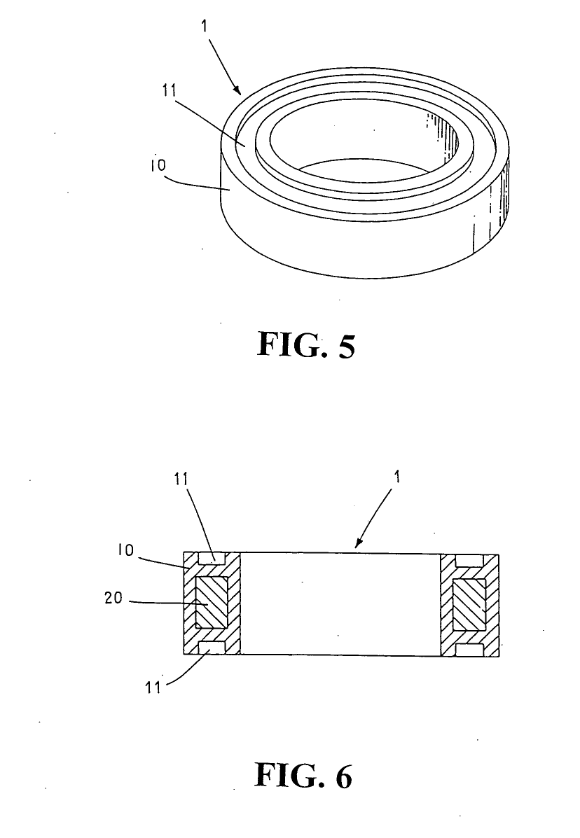

Now referring to FIGS. 5 and 6, the metal ring (20) is directly clad in and integrated with the inner wall of the ring body (10) to better secure both of the metal ring (20) and the ring body (10) in place and to save the manual insertion of the metal ring (20) to the ring body (10). Furthermore, two slots (11) are each respectively provided on the top and the bottom of the ring body (10) to reduce the contact area of impact. Accordingly the ring body (10) gives better resilience without compromising its compression strength to help reduce the impacts.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

1-3. (canceled)

4. A muffler washer for a draft link for a mold base comprising:
a ring body made of resin and having a center hole for receiving an end of said draft link, said ring body having a top side and a bottom side, said top and bottom sides being each formed with an annular slot to reduce contact area of impact; and
a metal ring clad in said ring body.
